(19) United States
(12) Patent Application Publication
(10) Pub. No.: US 2024/0080944 A1
(43) Pub. Date: Mar. 7, 2024

(54) HEATER WIRE AND HEAT-EMITTING ELEMENT

(71) Applicant: TOTOKU INC., Tokyo (JP)

(72) Inventors: Hiroaki SUGIMOTO, Ueda-shi, Nagano (JP); Takeyasu NAKAYAMA, Ueda-shi, Nagano (JP); Daisuke TANAKA, Ueda-shi, Nagano (JP)

(21) Appl. No.: 18/280,387

(22) PCT Filed: Sep. 3, 2021
(86) PCT No.: PCT/JP2021/032375

§ 371 Date: Sep. 5, 2023

(30) Foreign Application Priority Data
Jul. 19, 2021 (JP) 2021-118390

(51) Int. Cl. H05B 3/18; H01B 3/30; H05B 3/56

(52) U.S. Cl. CPC H05B 3/18; H01B 3/30; H05B 3/56; H05B 2203/007

(57) ABSTRACT

A heater wire that allows for reduced costs by adopting a novel structure capable of preventing localized abnormal temperatures while having a high bending durability and accommodating diameter reduction. The heater wire is provided with a heat-emitting part in which heat-emitting wires are wound in a spiral manner around a fiber core, and a sheath arranged around the heat-emitting part. The heat-emitting wires are configured such that a first heat-emitting wire including a first metal element wire and a second heat-emitting wire including an insulating film provided around a second metal element wire are wound in an alternating manner.

### TECHNICAL FIELD

The present invention relates to a heater wire having excellent flexibility and a heat-emitting element including the heater wire.

### BACKGROUND ART

Heater wires are used, for example, as heat-emitting sources for vehicle heating members and heat-emitting sources for general heating products. In the related art, there has been proposed a configuration in which a plurality of heat-emitting wires are helically wound around an outer circumference of a fiber core and a sheath is provided (PTL 1: JP-A-S61-047087). Further, for the purpose of improving flexibility, a configuration using a plurality of wires sheathed with an insulating film made of fluororesin has been proposed (PTL 2: JP-A-2013-020951).

As described in PTL 1 and PTL 2, in a structure in the related art, it has become common technical knowledge that each heat-emitting wire has to have an insulating sheath on the wire. In other words, in a case where each heat-emitting wire is a bare conductor, when one wire is broken, change in the overall resistance value is small, but the broken point has a high resistance locally. Therefore, an amount of heat emission at the broken point increases. As a result, there is a problem that an abnormally high temperature is generated locally. In contrast, in a case where each heat-emitting wire is sheathed with insulation, when one wire is broken, a resistance value of the entire wire will increase to that extent. Therefore, an amount of heat emission will decrease as a whole. As a result, an abnormally high temperature is prevented from being generated at the broken point.

### CITATION LIST

### Patent Literature

PTL 1: JP-A-S61-047087
PTL 2: JP-A-2013-020951

### SUMMARY OF INVENTION

### Technical Problem

However, heater wires used in automobile seats, and the like, are required to have high bending durability, and are required to have a function to warm immediately (quick warming-up function). In order to cope with this, wiring with a narrow pitch is required, and therefore reduction in diameter is required. In contrast, since the structure in which each heat-emitting wire has an insulating film requires material costs and man-hours, it is actually difficult to meet all the requirements for high bending durability, reduction in diameter, and reduction in costs.

### Solution to Problem

The present invention is made in view of the above described circumstances, and an object of the present invention is to provide a heater wire capable of achieving reduction in costs by adopting a novel structure capable of preventing local abnormal high temperatures while having high bending durability and coping with reduction in diameter.

The present invention has been accomplished under the solutions as disclosed below.

According to the present invention, a heater wire includes: a heat-emitting portion in which a heat-emitting wire is helically wound around an outer circumference of a fiber core; and a sheath that is disposed around an outer circumference of the heat-emitting portion. The heat-emitting wire is formed by alternately winding a first heat-emitting wire made of a first metal wire and a second heat-emitting wire having an insulating film provided around an outer circumference of a second metal wire.

With such a configuration, the first heat-emitting wire without an insulating film and the second heat-emitting wire with an insulating film are alternately helically wound around the outer circumference of the fiber core. With such a structure, since the insulation between the first heat-emitting wire and the second heat-emitting wire can be maintained, it is possible to prevent localized abnormal high temperatures. As a result, it is possible to achieve reduction in costs while having high bending durability and coping with reduction in diameter.

According to the heater wire of the present invention, it is preferable that the heater wire further includes a collecting portion in which one or a plurality of the first heat-emitting wires and one or a plurality of the second heat-emitting wires are disposed, the plurality of the first heat-emitting wires are wound by being spaced apart from each other in a case where the first heat-emitting wires are provided, and the first heat-emitting wire and the second heat-emitting wire are in contact with each other. With such a configuration, in a case where the number of the first heat-emitting wires is one, the insulating property is maintained, and the collecting portion is able to quickly warm the heat-emitting wire. Therefore, it is possible to easily cope with wiring with a narrow pitch. Further, in a case where there are a plurality of the first heat-emitting wires, it is possible to quickly warm the wires by using the collecting portion while maintaining insulation by spacing the first heat-emitting wires apart from each other. Therefore, it is possible to easily cope with wiring with a narrow pitch.

According to the heater wire of the present invention, it is preferable that a conductor diameter of the heat-emitting wire is in a range of 0.03 to 0.15 mm, and the number of the heat-emitting wires is in a range of 2 to 10. With such a configuration, it is possible to quickly warm the wires by using the collecting portion while sufficiently meeting the requirement for reduction in diameter, and it is possible to easily cope with wiring with a narrow pitch.

According to the heater wire of the present invention, it is preferable that the insulating film is made of one or more of polyurethane, polyesterimide, polyimide, polyamideimide, lubricating nylon, and lubricating polyamideimide. For example, the insulating film may have a multilayer structure. In such a case, the insulating film may have a lower layer and an upper layer. The lower layer is made of one or more of polyurethane, polyesterimide, polyimide, or polyamideimide. The upper layer is made of lubricating nylon or lubricating polyamideimide.

A heat-emitting element according to the present invention is characterized in that the heater wire according to the present invention described above is disposed therein.

### Advantageous Effects of Invention

According to the present invention, the first heat-emitting wire without an insulating film and the second heat-emitting wire with an insulating film are alternately helically wound around the outer circumference of the fiber core. With such a structure, since the insulation between the first heat-emitting wire and the second heat-emitting wire can be maintained, it is possible to prevent localized abnormal high temperatures. As a result, it is possible to implement a heater wire capable of achieving reduction in costs while having high bending durability and coping with reduction in diameter. Further, by using the heater wire according to the present invention, it is possible to prevent a localized abnormally high temperature due to breaking of wire and implement a heat-emitting element having a structure excellent in bending durability.

### BRIEF DESCRIPTION OF DRAWINGS

FIG. 1 is a schematic structural diagram showing a first example of a heater wire according to an embodiment of the present invention.

FIG. 2A is a schematic sectional view showing a second example of the heater wire according to the present embodiment, FIG. 2B is a schematic sectional view showing a third example of the heater wire according to the present embodiment, and FIG. 2C is a schematic sectional view showing a fourth example of the heater wire according to the present embodiment.

FIG. 3A is a schematic sectional view showing an example of a first heat-emitting wire according to the present embodiment, FIG. 3B is a schematic sectional view showing a first example of a second heat-emitting wire according to the present embodiment, and FIG. 3C is a schematic sectional view showing a second example of the second heat-emitting wire according to the present embodiment.

FIG. 4 is an explanatory diagram for explaining a bending test of a heater wire.

### DESCRIPTION OF EMBODIMENTS

[Heater Wire]

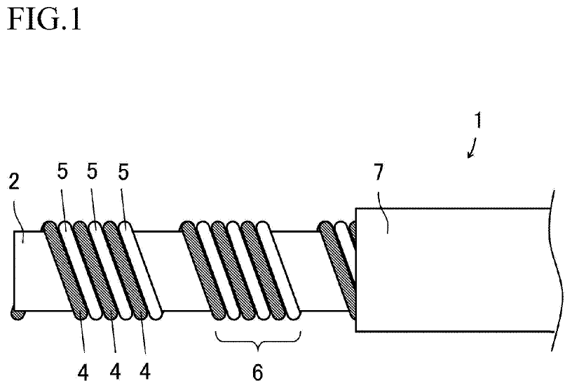

Hereinafter, an embodiment according to the present invention will be described in detail with reference to the drawings. As shown in FIGS. 1, 2A to 2C, and 3A to 3C, a heater wire 1 of the present embodiment includes: a heat-emitting portion in which a heat-emitting wire is helically wound around an outer circumference of a fiber core 2; and a sheath 7 that is disposed around an outer circumference of the heat-emitting portion. The heat-emitting wire is formed by alternately winding a first heat-emitting wire 4 made of a first metal wire 4a and a second heat-emitting wire 5 provided with an insulating film 5b around an outer circumference of a second metal wire 5a. In all drawings for describing the embodiment, the same reference numerals will be assigned to members having the same function, and repeated description thereof may be omitted in some cases.

In the first example, as shown in FIG. 1, the first heat-emitting wires 4 and the second heat-emitting wires 5 are alternately wound around the outer circumference of the fiber core 2. Here, three first heat-emitting wires 4 and three second heat-emitting wires 5 are disposed. The first heat-emitting wire 4 and the first heat-emitting wire 4 are wound with a spacing. The second heat-emitting wire 5 and the second heat-emitting wire 5 are wound with a spacing. A collecting portion 6, in which the first heat-emitting wire 4 and the second heat-emitting wire 5 are in contact with each other, is disposed with a predetermined pitch.

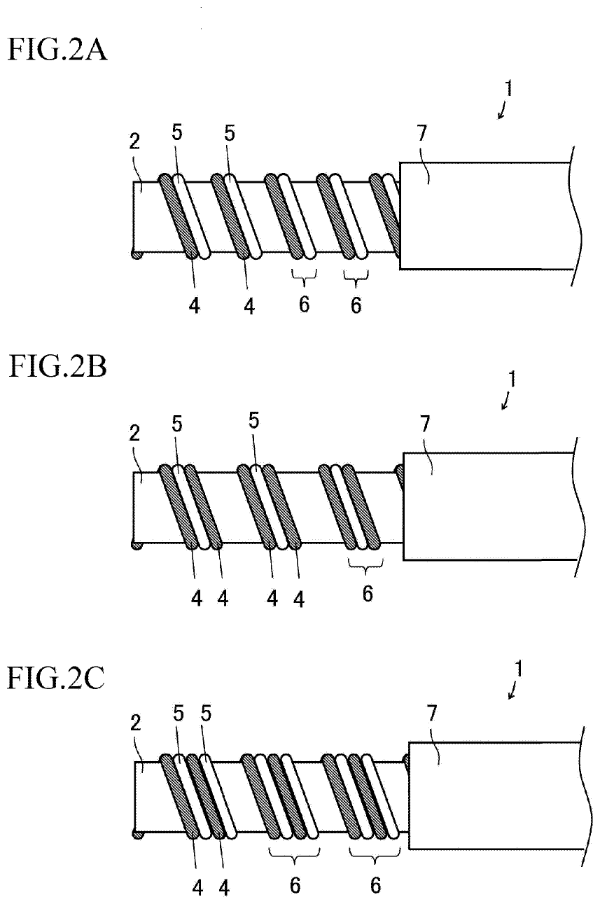

In the second example, as shown in FIG. 2A, the first heat-emitting wires 4 and the second heat-emitting wires 5 are alternately wound around the outer circumference of the fiber core 2. Here, one first heat-emitting wire 4 and one second heat-emitting wire 5 are disposed. The first heat-emitting wire 4 and the first heat-emitting wire 4 are wound with a spacing. The second heat-emitting wire 5 and the second heat-emitting wire 5 are wound with a spacing. A collecting portion 6, in which the first heat-emitting wire 4 and the second heat-emitting wire 5 are in contact with each other, is disposed with a predetermined pitch.

In the third example, as shown in FIG. 2B, the first heat-emitting wires 4 and the second heat-emitting wires 5 are alternately wound around the outer circumference of the fiber core 2. Here, two first heat-emitting wires 4 and one second heat-emitting wire 5 are disposed. The first heat-emitting wire 4 and the first heat-emitting wire 4 are wound with a spacing. The second heat-emitting wire 5 and the second heat-emitting wire 5 are wound with a spacing. A collecting portion 6, in which the first heat-emitting wire 4 and the second heat-emitting wire 5 are in contact with each other, is disposed with a predetermined pitch. In addition to the above description, the number of the first heat-emitting wires 4 may be one and the number of the second heat-emitting wires 5 may be two.

In the fourth example, as shown in FIG. 2C, the first heat-emitting wires 4 and the second heat-emitting wires 5 are alternately wound around the outer circumference of the fiber core 2. Here, two first heat-emitting wires 4 and two second heat-emitting wires 5 are disposed. The first heat-emitting wire 4 and the first heat-emitting wire 4 are wound with a spacing. The second heat-emitting wire 5 and the second heat-emitting wire 5 are wound with a spacing. A collecting portion 6, in which the first heat-emitting wire 4 and the second heat-emitting wire 5 are in contact with each other, is disposed with a predetermined pitch.

The predetermined pitch when the first heat-emitting wire 4 and the second heat-emitting wire 5 are helically wound is a pitch corresponding to a diameter of the fiber core 2 and the number and a diameter of the heat-emitting wires. For example, the pitch when the wires are helically wound is in a range of 0.2 to 2.5 mm.

For example, the first metal wire 4a and the second metal wire 5a are made of the same material and are set to have the same conductor diameter. For example, the first metal wire 4a and the second metal wire 5a may be made of different materials and may be set to have different conductor diameters. It is preferable that the first metal wire 4a and the second metal wire 5a are copper wires or copper alloy wires. Examples of the copper alloy wire may include Cu—Ag alloy, Cu—Sn alloy, Cu—Ni alloy and the like. Solder plating, tin plating, gold plating, silver plating, nickel plating, or the like may be applied to surfaces of the metal wires.

A practical total number of the first heat-emitting wires 4 and the second heat-emitting wires 5 is in a range of 2 to 10. Thereby, an axial length of the collecting portion 6 can be kept within a certain range, and favorable flexibility can be maintained. More preferably, the total number of the first heat-emitting wires 4 and the second heat-emitting wires 5 is in a range of 2 to 7. Conductor diameters of the first heat-emitting wire 4 and the second heat-emitting wire 5 are in a range of 0.03 to 0.2 mm. More preferably, the diameters are in a range of 0.03 to 0.15 mm. Thereby, it is possible to quickly warm the wires by using the collecting portion while sufficiently meeting the requirement for reduction in diameter, and it is possible to easily cope with wiring with a narrow pitch.

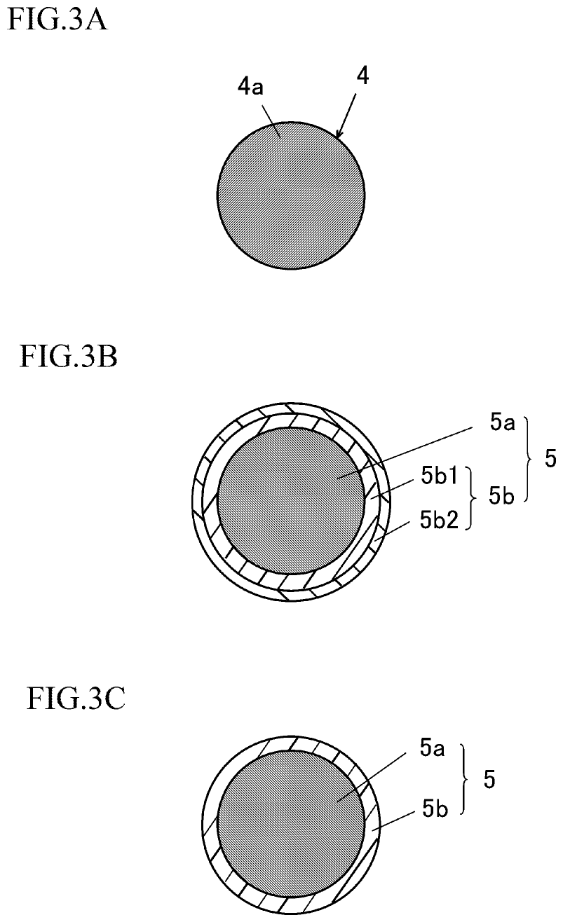

As shown in FIG. 3A, the first heat-emitting wire 4 is made of the first metal wire 4a and does not have an insulating film. Here, in the present specification, the insulating film is a non-metallic film such as a polymer compound, and the metal oxide film is not applied thereto.

As shown in FIGS. 3B to 3C, the second heat-emitting wire 5 is provided with an insulating film 5b around the outer circumference of the second metal wire 5a. The insulating film 5b employs a heat-resistant material, and is made of one or more of polyurethane, polyesterimide, polyimide, lubricating nylon, and lubricating polyamideimide.

In a case where the insulating film 5b is made of any one or more of polyurethane, polyesterimide, polyimide, or polyamideimide, a thickness of the insulating film 5b is substantially specified in Japanese Industrial Standard (JIS C 3202:2014) Type 1, Type 2, or Type 3, and the thickness is appropriately selected in accordance with the application and size. The insulating film 5b is formed to have a desired thickness by a baking process.

The insulating film 5b may have a multilayer structure in which polyurethane, polyesterimide, polyimide, or polyamideimide is used as a lower layer and lubricating nylon or lubricating polyamideimide is used as an upper layer. In such a case, the polyurethane, polyesterimide, polyimide, or polyamideimide is subjected to the baking process by using the baking device, and subsequently overcoated with lubricating nylon or lubricating polyamideimide through, for example, one pass (coating is performed on the layer once, thereafter processed by heat treatment). In such a case, a thickness of the lubricating nylon or lubricating polyamideimide is preferably in the range of 0.1 to 3 μm. Examples of lubricating nylon include nylon 66 and the like. Examples of lubricating polyamideimides include polyamideimides obtained by adding additives (for example, polyethylene, and the like) to polyamideimides to improve lubricity. Such lubricating nylon or lubricating polyamideimide causes lubricity on the surface of the second heat-emitting wire 5. As a result, even when the wire is repeatedly bent under loads, the wire is unlikely to be broken, and an increase in costs can be suppressed. The loads include loads at the time of manufacturing (for example, stress applied when the wire passes through a plurality of pulleys, stress concentration based on overlapping of the heat-emitting wires during winding, and the like), loads at the time of wiring (stress applied when the wire is bent and disposed, and the like), and loads at the time of installation (repeated stress at the time of seating in a case where the wire is used as a heater wire for seats, and the like). Since lubricating nylon or lubricating polyamideimide has low volatility such as liquid paraffin, the problem of volatilization does not occur. In addition, it is also possible to overcoat with silicone oil instead of lubricating nylon or lubricating polyamideimide.

In a case where the insulating film 5b is made of lubricating nylon or lubricating polyamideimide, the thickness of the insulating film 5b is, for example, in a range of 0.1 to 3 μm. Examples of lubricating nylon include nylon 66 and the like. Examples of lubricating polyamideimides include polyamideimides obtained by adding additives (for example, polyethylene, and the like) to polyamideimides to improve lubricity. Such lubricating nylon or lubricating polyamideimide causes lubricity on the surface of the second heat-emitting wire 5. As a result, even when the wire is repeatedly bent under loads, the wire is unlikely to be broken, and an increase in costs can be suppressed. The loads include loads at the time of manufacturing (for example, stress applied when the wire passes through a plurality of pulleys, stress concentration based on overlapping of the heat-emitting wires during winding, and the like), loads at the time of wiring (stress applied when the wire is bent and disposed, and the like), and loads at the time of installation (repeated stress at the time of seating in a case where the wire is used as a heater wire for seats, and the like). In addition, lubricating nylon or lubricating polyamideimide does not cause the problem of volatilization because liquid paraffin or the like has low volatility.

In the first example of the second heat-emitting wire 5, a first insulating film 5b1 is formed around the outer circumference of the second metal wire 5a, and a second insulating film 5b2 made of a material different from the first insulating film 5b1 is formed around the outer circumference of the first insulating film 5b1. In the second example of the second heat-emitting wire 5, a single-layer insulating film 5b is formed around the outer circumference of the second metal wire 5a. For example, the thickness of the insulating film 5b is in a range of 0.1 to 15 μm. By setting the thickness of the insulating film 5b in a range of 0.1 μm or more, the insulating property can be ensured. Further, by setting the thickness of the insulating film 5b to 15 μm or less, it is possible to easily obtain a more uniform structure by reducing a difference in dimension between the first heat-emitting wire 4 and the second heat-emitting wire 5 while maintaining the film strength. It should be noted that the insulating film 5b may have three or more layers in accordance with the application.

The fiber core 2 has a function as a winding core, and is preferably a high tension body. The fiber core 2 is, for example, a fiber thread in which a plurality of fibers are bundled. It is preferable that the fibers constituting the fiber thread have a strength and a heat resistance required for the heater wire 1. Examples of fibers constituting the fiber thread may include polyester fibers such as Tetoron (registered trademark), wholly aromatic polyamide fibers such as Kevlar (registered trademark), polyarylate fibers such as Vectran (registered trademark), and glass fibers. Further, the fiber core 2 may be a composite fiber obtained by combining fibers of different materials or fiber threads with different outer diameters.

The fiber core 2 has a concentric (perfectly circular) or substantially concentric cross section by assembling, twisting, or braiding the fiber threads. In order to make the fiber core 2 to have a concentric or substantially concentric cross section, it is more preferable to use twisted fiber threads. For example, the fiber core 2 has an outer diameter ranging from 0.1 to 1.0 mm. Thereby, favorable flexibility can be maintained, and the requirement for reduction in diameter can be sufficiently met. More preferably, the fiber core 2 has an outer diameter ranging from 0.1 to 0.4 mm. The fiber core 2 made of fiber thread is flexible and tends to be deformed. Therefore, the outer diameter of the fiber core 2 is estimated as an outer diameter thereof in a case where the fiber core 2 is perfectly circular, and is estimated as an outer diameter, which is converted from the cross-sectional area to the cross-sectional area of a perfect circle, in a case where the fiber core 2 is flat.

The fiber core 2 is generally defined by a denier (dtex), which indicates a weight of the fiber thread. 1 dtex is 1 g at a length of 10000 m. The range of dtex of the fiber core 2 is preferably a range of 110 to 2000 dtex. Such a fiber core 2 may be made of a single fiber thread, or may be made of two or more kinds of fiber threads. In a case where the fiber core 2 is constituted of two or more types of fiber threads, the total dtex may be within the above described range. At 110 dtex or more, a necessary durability can be ensured. At 2000 dtex or less, there is no particular problem with workability and processability.

The sheath 7 is a sheath that covers the first heat-emitting wire 4 and the second heat-emitting wire 5. For example, the first heat-emitting wire 4 and the second heat-emitting wire 5 can be disposed, and then formed by resin extrusion or the like so as to cover the outer circumferences of the heat-emitting wires. A constituent material of the sheath 7 is a resin material which has the insulating property and heat resistance. It is preferable that the sheath 7 is made of PVC (polyvinyl chloride), nylon, polyester elastomer, ETFE, FEP, or PFA fluorine-based resin. Alternatively, the sheath 7 can be made of polyolefin such as polyethylene or polyester such as polyethylene terephthalate. The thickness of the sheath 7 varies depending on the outer diameter dimension of the heat-emitting portion and the final outer diameter of the heater wire 1, but is preferably in a range of about 0.05 to 1.0 mm, and more preferably in a range of 0.10 to 0.30 mm. For example, the heater wire 1 has an outer diameter ranging from 0.5 to 2.0 mm. More preferably, the heater wire 1 has an outer diameter ranging from 0.5 to 1.5 mm.

It is preferable that the sheath 7 is formed by resin extrusion. The sheath 7 formed by the extrusion tends to have a constant thickness, and the unevenness of the surface thereof can be reduced. By providing such a sheath 7 formed by the extrusion as the outermost layer, it is possible to have the effect of preventing local bending even in a case where the diameter is reduced for wiring with a narrow pitch. As a result, it is possible to achieve reduction in diameter to such an extent that there is no sense of incongruity at the time of sitting on the seat, and it is possible to perform wiring with a narrow pitch in the case of the heat-emitting element. In addition, it is possible to improve bending durability.

Next, the heat-emitting element provided with the above described heater wire 1 will be described below.

[Heat-Emitting Element]

The heat-emitting element of the present embodiment is, for example, a seat heater, in which the heater wire 1 is disposed. Since the heater wire 1 has high flexibility, desired wiring can be easily performed by sewing the heater wire 1 to a seat body such as a seat base material constituting the heat-emitting element.

For example, the heat-emitting element of the present embodiment can be applied to heating products such as electric carpets and electric blankets, and heating members for vehicles such as seat heaters and steering heaters. It is preferable that the heat-emitting element can be attached to an automobile seat. In the case of the heat-emitting element as a heating member for automobiles, the heater wire 1 is sewn into an object such as a seat base material.

The sewing of the heater wire 1 into the seat base material prevents the appearance of the heater wire 1 from being damaged by the influence of the volatile gas, and is unlikely to cause friction between the first heat-emitting wire 4 and the second heat-emitting wire 5 and the sheath 7. As a result, the sewing can be performed with favorable wiring. When the heater wire 1 is wired and sewn, the structure is highly resistant to the stress applied to the heater wire 1. Therefore, the diameter can be reduced to the extent that there is no sense of incongruity at the time of sitting on the seat. Further, in a case of the heat-emitting element, the wiring with the narrow pitch becomes possible.

Next, examples, a reference example, and a comparative example of the heater wire 1 according to the present embodiment will be described as follows.

### Example 1

As the fiber core 2, a bundle of polyester threads having an outer diameter of 0.25 mm was used. As the first heat-emitting wire 4, a first metal wire 4a was used, which was obtained by drawing a copper-tin alloy wire (containing 0.3% by mass of tin) to have an outer diameter of 0.09 mm. As the second heat-emitting wire 5, a wire was used, in which a first insulating film 5b1 was formed around the outer circumference of the second metal wire 5a which is made by drawing a copper-tin alloy wire to have an outer diameter of 0.09 mm and a second insulating film 5b2 was formed around the outer circumference of the first insulating film 5b1. The first insulating film 5b1 was formed by baking and coating polyesterimide such that a thickness of polyesterimide is 10 μm. The second insulating film 5b2 was formed by applying lubricating polyamide such that a thickness of lubricating polyamide is 2 μm. On the fiber core 2, six heat-emitting wires were helically laterally wound at a pitch of 1.5 mm such that six heat-emitting wires formed a single layer all together. The heat-emitting wire is wound the first heat-emitting wire 4 and the second heat-emitting wire 5 alternately. The sheath 7 was formed by melting and extruding polyester such that the outer diameter of the heater wire 1 was 1.0 mm. In such a manner, the heater wire 1 was produced.

### Example 2

As the second heat-emitting wire 5, a wire is used, which is formed by forming an insulating film 5b around the outer circumference of the second metal wire 5a which is made by drawing a copper-tin alloy wire to have an outer diameter of 0.09 mm. The insulating film 5b was formed by applying lubricating polyamide such that a thickness of the lubricating polyamide is 2 μm. The configuration other than the above described configuration is the same as Example 1.

### Reference Example

As the first heat-emitting wire, a wire was used, in which the first insulating film was formed around the outer circumference of the first metal wire which is made by drawing a copper-tin alloy wire to have an outer diameter of 0.09 mm and the second insulating film was formed around the outer circumference of the first insulating film. The first insulating film was formed by baking and coating polyesterimide such that a thickness of polyesterimide is 10 μm. The second insulating film was formed by applying lubricating polyamide such that a thickness of the lubricating polyamide is 2 μm. The configuration other than the above described configuration is the same as Example 1.

### Comparative Example

As the first heat-emitting wire, a first metal wire was used, which was obtained by drawing a copper-tin alloy wire to have an outer diameter of 0.09 mm. As the second heat-emitting wire, a second metal wire was used, which was obtained by drawing a copper-tin alloy wire to have an outer diameter of 0.09 mm. The configuration other than the above described configuration is the same as Example 1.

### Characteristic Evaluation

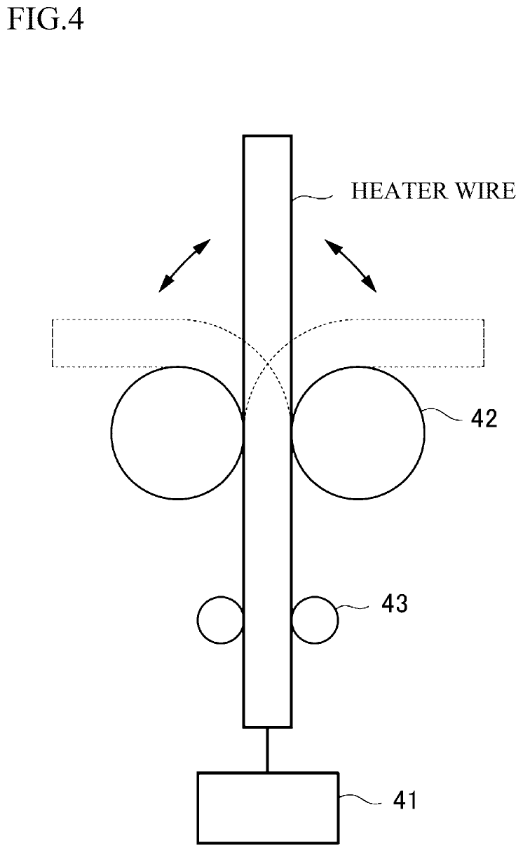

In the bending durability test, as shown in FIG. 4, a heater wire having a length of 1000 mm produced in each of the examples and the comparative example was interposed between mandrels 42, 42 having a radius of 5 mm, and a load 41 was attached to the lower end portion of the heater wire, and the number of times of bending was measured by bending each side by 90 degrees, at a speed of 30 times per minute, in a direction perpendicular to the mandrel 42. The flexibility thereof was evaluated by the number of times until all the first metal wires and the second metal wires were broken.

Table 1 shows evaluation results of samples.

TABLE 1

| | Example | Example | Reference | Comparative |
|---|---|---|---|---|
| | 1 | 2 | Example | Example |
| Countermeasure | ◯ | ◯ | ◯ | X |
| against local heat | | | | |
| emission | | | | |
| Bending test | 40,000 | 37,000 | 40,000 | 35,000 |
| result | times | times | times | times |

As shown in Table 1, the number of times of bending of each of the heater wires 1 of Examples 1 and 2 was 37,000 times or more. In contrast, in the comparative example, the number of times of bending remained at 35,000 times. In particular, in Example 1, the number of times of bending reached 40,000 times, which is equivalent to that of Reference Example. In the reference example, all the heat-emitting wires are enameled wires. Therefore, the production lead time is long, and the material costs and the like increase. In the comparative example, all of the heat-emitting wires are bare conductor wires, and no countermeasure against local heat emission is implemented. Therefore, the operational durability is inferior.

The present invention is not limited to the embodiment described above, and various modifications can be made within the scope not departing from the present invention.

1.-5. (canceled)

6. A heater wire comprising:
a heat-emitting portion in which a heat-emitting wire is helically wound around an outer circumference of a fiber core; and
a sheath that is disposed around an outer circumference of the heat-emitting portion,
wherein the heat-emitting wire is formed by alternately winding a first heat-emitting wire made of a first metal wire and a second heat-emitting wire having an insulating film provided around an outer circumference of a second metal wire.

7. The heater wire according to claim 6, further comprising a collecting portion in which one or a plurality of the first heat-emitting wires and one or a plurality of the second heat-emitting wires are disposed, the plurality of the first heat-emitting wires are wound by being spaced apart from each other in a case where the first heat-emitting wires are provided, and the first heat-emitting wire and the second heat-emitting wire are in contact with each other.

8. The heater wire according to claim 6, wherein a conductor diameter of the heat-emitting wire is in a range of 0.03 to 0.15 mm, and the number of the heat-emitting wires is in a range of 2 to 10.

9. The heater wire according to claim 7, wherein a conductor diameter of the heat-emitting wire is in a range of 0.03 to 0.15 mm, and the number of the heat-emitting wires is in a range of 2 to 10.

10. The heater wire according to claim 6, wherein the insulating film is made of one or more of polyurethane, polyesterimide, polyimide, polyamideimide, lubricating nylon, and lubricating polyamideimide.

11. The heater wire according to claim 7, wherein the insulating film is made of one or more of polyurethane, polyesterimide, polyimide, polyamideimide, lubricating nylon, and lubricating polyamideimide.

12. The heater wire according to claim 8, wherein the insulating film is made of one or more of polyurethane, polyesterimide, polyimide, polyamideimide, lubricating nylon, and lubricating polyamideimide.

13. A heat-emitting element comprising the heater wire according to claim 6.

14. A heat-emitting element comprising the heater wire according to claim 7.
